(19) United States
(12) Patent Application Publication
(10) Pub. No.: US 2026/0049584 A1
(43) Pub. Date: Feb. 19, 2026

(54) EVANESCENT OR FUGACIOUS THRUST DEFLECTOR

(71) Applicant: The Aerospace Corporation, El Segundo, CA (US)

(72) Inventor: Jerome K. FULLER, Van Nuys, CA (US)

(73) Assignee: The Aerospace Corporation, El Segundo, CA (US)

(21) Appl. No.: 19/363,979

(22) Filed: Oct. 21, 2025

Related U.S. Application Data
(63) Continuation-in-part of application No. 18/053,294, filed on Nov. 7, 2022, now Pat. No. 12,473,876.

(51) Int. Cl. F02K 9/97; B64G 1/40; F02K 1/00

(52) U.S. Cl. CPC F02K 9/974; F02K 1/002; B64G 1/40

(57) ABSTRACT

A motor configured to transition from generating thrust in an axial direction to generating thrust in a radial direction. The motor comprises an annular vane set configured to produce torque in an axial direction when propellant flows through a nozzle. The motor also includes an ablative cap, which includes a timing hole for generating thrust in a radial direction, transitioning from producing torque to generating thrust.

### CROSS REFERENCE OF RELATED APPLICATIONS

This application is a continuation-in-part of, and claims priority to, U.S. application Ser. No. 18/053,294, filed on Nov. 7, 2022. The subject matter of the earlier filed application is incorporated herein by its entirety.

### STATEMENT OF GOVERNMENT INTEREST

This invention was made with government support under Contract No. FA8802-19-C-0001 awarded by the Department of the Air Force. The government has certain rights in the invention.

### FIELD

The present invention relates to thrusters, and more particularly, to an evanescent or fugacious thrust deflector.

### BACKGROUND

The Federal Communications Commission (FCC) requires that US satellites be deorbited or removed to “parking” orbits at the end of their lifetimes. Small satellites, typically flying in low Earth orbits (LEOs), don't have “parking” orbits and are often degraded and unable to perform additional maneuvers at the end of their lifetimes.

As CubeSats and other small satellites become more pervasive, solutions to remove decommissioned satellites from orbit are essential. A new space company, D-Orbit™, launched a CubeSat otherwise known as D-SAT™, that attempted to lower its orbit through a deorbiting maneuver, but resulted in an orbit-raising maneuver.

Alignment of ammonium perchlorate composite propellant (APCP) motors to a theoretical thrust line running through the satellite's actual center of mass at time of deorbit is extremely difficult. Further, APCP motors build up alumina “slag” in the nozzle throat, in effect, acting as a randomly appearing thrust vector control (TVC) element. Small satellite programs generally cannot accommodate active TVC systems. Reaction wheel steering, designed for typical daily satellite use, usually has insufficient control authority to overcome these problems during a composite solid burn.

Thrust deflectors have been used in TVC systems for many decades, actively directing rocket motor exhaust to create a torque to change or restore a course heading. These systems are necessarily complex and present a monetary cost and system performance cost due to their mass, and in at least many cases, the obstruction of gas flow that would otherwise add to the overall thrust, even when not actively correcting the flight path. Additionally, they impose a burden on system design and testing that may be onerous for small teams.

Accordingly, an improved thrust deflector may be beneficial.

### SUMMARY

Certain embodiments of the present invention may provide solutions to the problems and needs in the art that have not yet been fully identified, appreciated, or solved by current thrust deflecting technologies. For example, some embodiments of the present invention pertain to an ablative or evanescent or fugacious thrust deflector. For example, some embodiments achieve a passively stable axially-symmetric burn by spinning the satellite, however simple spinning options such as pointing multiple nozzles to create the spin could cause a satellite to spin too quickly by the end of the burn and potentially shred itself. Thus, a spinning technique that is functionally separate from the thrusting motor is desired. Although the use of a spin motor could accomplish this goal, it would also require a separate accommodation with a separate set of risks.

In an embodiment, a motor configured to transition from generating thrust in an axial direction to generating thrust in a radial direction. The motor comprises an annular vane set configured to produce torque in an axial direction when propellant flows through a nozzle. The motor also includes an ablative cap, which includes a timing hole for generating thrust in a radial direction, transitioning from producing torque to generating thrust.

In another embodiment, an apparatus includes a nozzle configured to control a flow of thrust from the apparatus, and an ablative material inside of or attached to the nozzle, configured to deflect the thrust at a predefined angle. The ablative material being configured to ablate-away, leaving un-deflected thrust for a majority of the burn. The apparatus also includes fugacious material configured to ablate-away, melt-away, or be removed by ablating or melting a portion of a supporting structure of the fugacious material. In another embodiment, The apparatus includes a meltable deflector attached to the inside of the nozzle using a meltable interface material. The meltable deflector is composed of a ceramic material or a metal, and is composed of polymers, elastomers, metals, or alloys.

In yet another embodiment, a motor includes an annular vane set configured to produce torque in an axial direction when propellant combustion products flow through a nozzle. The method also includes an ablative cap configured to generate thrust in a radial direction or along a longitudinal, transitioning the motor from producing the torque to generating thrust.

In another embodiment, a motor includes an annular vane set configured to produce torque in an axial direction when propellant combustion products flow through a nozzle. The method also includes a first ablative cap and a second ablative cap. The first ablative cap and the second ablative cap are configured to generate thrust in a radial direction or along a longitudinal, transitioning the motor from producing the torque to generating thrust when the annular vane set ablates or melts away.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a diagram illustrating a tractor motor comprising a deflector inserted within a nozzle at time 0 to time 3, according to an embodiment of the present invention.

FIG. 2 is a diagram illustrating an axial motor comprising an ablative disc inserted within a nozzle 210, according to an embodiment of the present invention.

FIG. 3 is a diagram illustrating a tractor motor comprising an ablative deflector 305 at time T_{Intial} to time T_{Final}, according to an embodiment of the present invention.

FIG. 4 illustrates diagrams (a)-(c) showing a cross-section of an aerospike nozzle furnished with a fugacious thrust deflector in the initial condition (a), according to an embodiment of the present invention.

FIGS. 5A and 5B are diagrams illustrating different views of a printed ceramic, graphite, or metalicdeflector, according to an embodiment of the present invention.

FIGS. 6A-C are diagrams illustrating a one-piece design where the fugacious element and the torque vanes are monolithic, according to an embodiment of the present invention.

FIGS. 7A-C diagrams illustrating a motor comprising ablating caps, according to an embodiment of the present invention.

### DETAILED DESCRIPTION OF THE EMBODIMENTS

Some embodiments generally pertain to a thrust deflector that ablates-away or melts away, or is eroded, leaving only un-deflected thrust for the majority of the burn. One configuration is suitable for tractor motors while a different configuration accommodates conventional axial-thrust motors. In some embodiments, the ablative material may be located in the nozzle or exhaust plume. Also, in some embodiment, the ablative material is configured to ablate away, leaving substantially undeflected thrust for a majority of the burn. Substantially, for purposes of explanation, means that there is an insignificant amount (e.g., less than 5 percent) of deflection remaining, since the remnants of the deflector may still be present.

For embodiments that pertain to tractor motors, a partial plug is affixed to the nozzle cone using an adhesive. The shape of the plug directs the thrust to one side, applying a torque. These motors generally have multiple nozzles with each nozzle applying similar torques in opposing pairs. The nozzle is made of an ablative material that ablates away at a predictable rate such that two radially-opposed nozzles would provide similar torques for similar periods. The torque may reduce in effect as the obstructing material is removed transitioning from thrust produced in an axial direction to a radial direction.

It should be appreciated that there may be ways other than ablation to accomplish removal of the obstructing material. For example, melting a plastic deflector may also work. Though undesirable because of the debris generated, a deflector made of ceramic, metal or another durable material may also be made to separate from the nozzle after a delay, perhaps by conducting heat to a meltable interface material between deflector and the nozzle or other part of the structure. Interface materials, which may melt or decompose to release a deflector, may include thermoplastic polymers (e.g., polyethylene or acrylonitrile butadiene styrene (ABS)), thermoset materials (e.g., polyimide) cross-linked materials (e.g., epoxy or rubber), elastomers (e.g., urethane and thermoplastic elastomer (TPE)). Ablation, however, may be another technique. For example, attachment of an ablative material to parts of the nozzle, or to other spacecraft or rocket structures, could additionally be made by welding, the use of fasteners, or even by the use of interlocking features. In some embodiments, the ablative material may include elements that are fabricated as a single part or placed within one or more other parts.

It should be appreciated that other materials may decompose without melting and may be used in some of the embodiments described herein. Such materials may include thermoset plastics, rubbers, and epoxies all of which can decompose without melting, still releasing a deflector.

It should also be noted that there is no specific need to attach the deflector part to the nozzle. The same result may be achieved by attaching the deflector to other parts. For example, the deflector may be mounted on the nozzle because that is where the device can be the smallest, but it may be more convenient to mount a deflector to elements of an engine mount or motor mount.

For embodiments that pertain to axially thrusting motors, an annulus with a set of curved blades, arranged around the motor centerline but beyond the nozzle exit diameter, mounts thrust deflectors made of an ablative material. The cover is ablated away leaving the motor plume to exhaust normally without applying further torque. The time spent spinning up versus thrusting normally is determined by the thickness, material, and shape of the deflector.

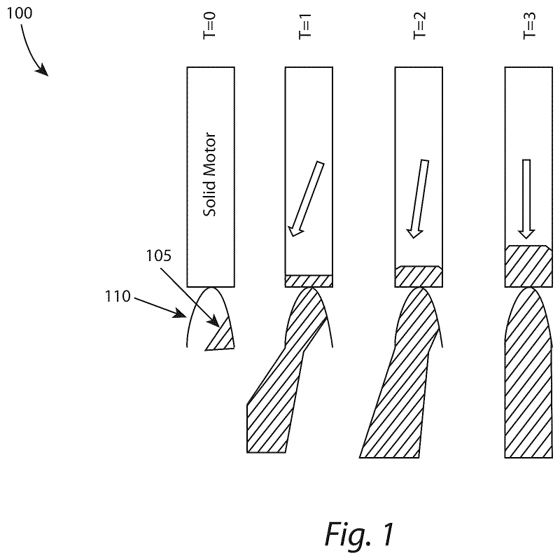

FIG. 1 is a diagram illustrating a tractor motor 100 comprising a deflector 105 inserted within a nozzle 110 at time 0 to time 3, according to an embodiment of the present invention. In some embodiments, deflective (ablative) material 105 is attached to the inside of a nozzle 110 by way of adhesive or some other material. In some embodiments, the adhesive is filled with additives to modify the ablation rate (e.g., an epoxy filled with ceramic particles).

Depending on the embodiment, thrust deflectors may be attached to nozzles by epoxy adhesive or by mechanical fasteners. In other embodiments, thrust deflectors may also be attached to other portions of the spacecraft, such as the rocket motor structure or the spacecraft structure, for temporarily deflecting the thrust. Thrust deflectors may also be attached to portions of a nozzle, including the converging, throat, or diverging portion of a nozzle, or to the nozzle bell or may be extended beyond the nozzle. They could be attached to other portions of the rocket motor or spacecraft body. Attachment methods could include mechanical fasteners, mechanical keying with interlocking features, adhesives or meltable layers, or by welding or chemical welding. Deflectors can be molded, cast, 3D-printed, or otherwise concurrently or monolithically fabricated, with a nozzle or other nozzle component. In this example, a nozzle might be designed with the deflector being a designed-in feature rather than a separate part requiring attachment.

In certain embodiments, a deflector may be referred to as fugacious deflectors, which may include a plurality of elements. These elements may include one or more planar shapes that cap a nozzle to force gas products through other elements (e.g., curved vanes). Other elements, such as conical shapes, may aid in turning the flow of gas more efficiently. These shapes may be combined into a single piece or assembled using various joining techniques. These elements may further comprise supporting structures or timing features, such as a pilot hole, that provides an initiation point for ablation or melting. A typical rocket motor or engine, firing axially (as opposed to a tractor), may employ a vane set and deflecting plate such that the plate prevents axial thrust, in part or in total, while allowing a torqueing thrust, until the deflecting plate is ablated or melted away, or is released by the ablating or stressing of a securing component.

Deflector 105 may deflect the thrust partially or gradually from tractor motor 100. Since a tractor motor 100 includes multiple nozzles, ablative deflector 105 may be inside of each nozzle 110. It should be noted that the current state of the art does not take into consideration the ablation in terms of timing to change from the side to thrusting straight down. See, for example, FIG. 1.

Using FIG. 1 as an example, assume there are four to eight nozzles 110, each of which include a deflective material 105 positioned on a CubeSat. In this example, if there is a single fuel grain that provides gases to the nozzles at the same time, there may be rotation around the long axis of the CubeSat. With this configuration, there is a timing feature, i.e., a passive TVC rather than an active TVC.

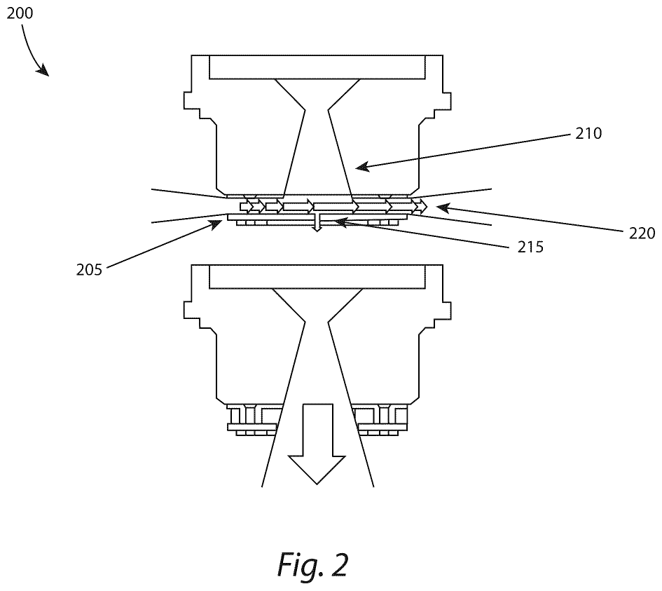

FIG. 2 is a diagram illustrating an axial motor 200 comprising an ablative disc 205 inserted within a nozzle 210, according to an embodiment of the present invention. In this embodiment, there is a single nozzle 210 that is on axis with the fuel grain and the rest of the CubeSat, and an ablative disc 205 with a hole 215 in the center. The hole 215 in this embodiment is configured to act as a timing feature. With this configuration, the thrust is deflected initially out of the vanes 220 in an axial direction with very little thrust exiting from hole 215. Over time, the thrust exits through hole 215 in the radial direction as hole 215 enlarges. The ablative disc 205 may be composed of polyimide plastic, for example.

Other materials may include other thermoset plastic materials, or thermoformed plastic materials, metals, composite materials (e.g., phenolic) or fiberglass, ceramic materials (e.g., alumina), semiconductor materials (e.g., silicon or silicon carbide), or carbon or hardened resins (e.g., epoxy). These materials may be formed by machining, molding, casting, 3D printing, or by laying-up or combining various materials, made by various methods.

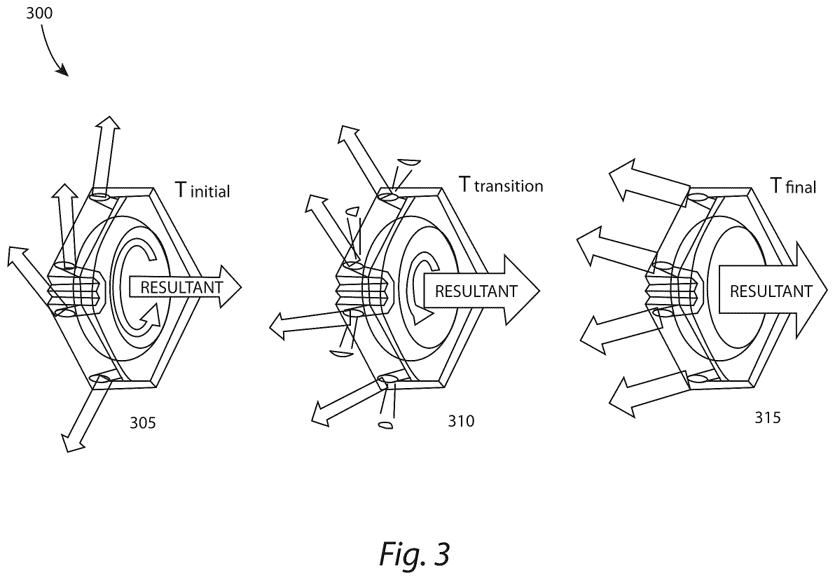

A rocket using an aerospike nozzle may employ an ablative (or fugacious) thrust deflector or an ablative (fugacious) element temporarily securing a thrust deflector. A deflecting element placed in the exiting flow of gases is oriented to deflect the gas, thereby producing torque. See, for example, FIG. 3. In the case of annular aerospike nozzles, it may be convenient to attach a disk-like ablative element at the tip of the spike so that curved or canted vanes or blades that are attached to or part of the disk redirect the axial thrust laterally while also directing the thrust into opposing tangential thrust components (i.e., in the radial direction). The disk shape may include a hub shape that extends an extension to the spike. Similarly, a more robust thrust deflecting element may be made with ablative material. One embodiment of this might be at least one meltable polymer element, such as a nylon fastener, so that conduction of heat through the nozzle or deflector or hot gasses might melt, or allow to be removed, an element securing the deflector.

FIG. 3 is a diagram illustrating a tractor motor 300 comprising an ablative deflector 305 at time T_{Intial} to time T_{Final}, according to an embodiment of the present invention. In this embodiment, tractor motor 300 includes ablative deflectors 305 inside of nozzles 310. Nozzles 310 are attached to or connected to an end-burning fuel grain 315.

In FIG. 3, tractor motor 300 includes eight ablative thrust deflectors. See, for example, position 305, position 310, and position 315 at various times. The thrust deflects are partly adhered to, and partly occluding, their associated nozzles such that during they at least partly deflect thrust laterally at Tᵢₙᵢₜᵢₐₗ, before ablating away at T_{final}, where the nozzles direct the thrust at least mostly axially.

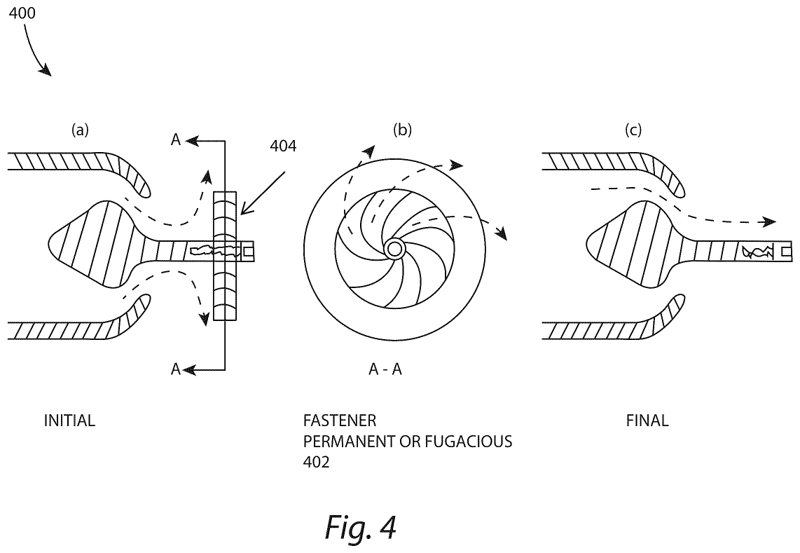

FIG. 4 illustrates diagrams (a)-(c) showing a cross-section of an aerospike nozzle furnished with a fugacious thrust deflector in the initial condition (a), according to an embodiment of the present invention. In some embodiments, 4(a) shows how thrust is initially deflected tangentially. A fastener or fugacious material (e.g., nylon) 402 is used to attach deflector 404. For example, in this simple example, the fastener or ablative material is secured to a threaded hole in the end of a spike, either with a meltable bolt so the entire component can be removed at once or so the deflector itself ablates away, leaving the bolt intact. In reality, there may be a circle of many bolts.

FIG. 4(b) shows a view (A-A) of the curved vanes of the deflector and some of the tangentially exiting gases, and FIG. 4(c) shows the final condition after the deflector is burned-away.

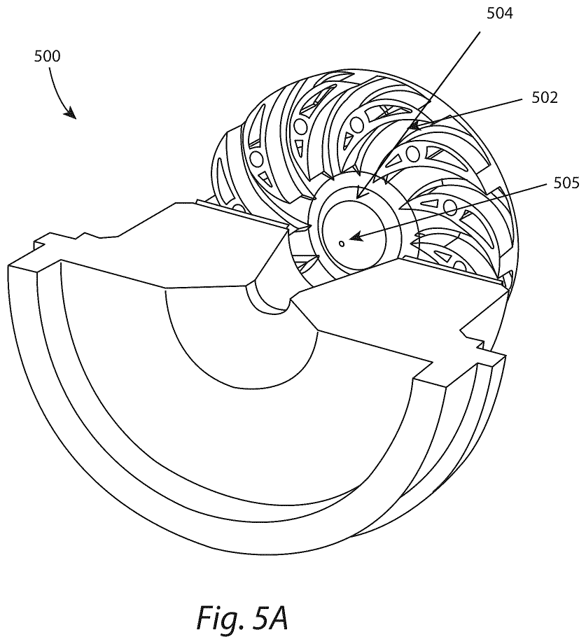

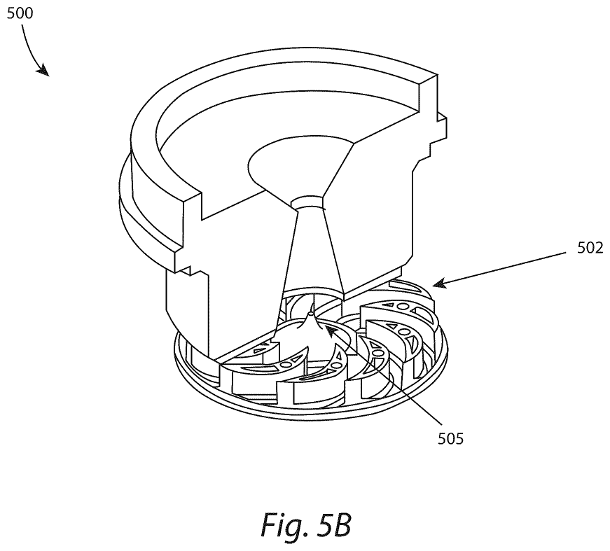

FIGS. 5A and 5B are diagrams illustrating different views of a printed ceramic deflector 500, according to an embodiment of the present invention. In some embodiments, printed ceramic deflector 500 includes a plurality of vanes 502 and capping surface 504. Both FIGS. 5A and 5B show an alternative arrangement whereby the through-hole 505 of an annulus mounting curved vanes is mostly or completely occluded. In this embodiment, the base surface that mounts the curved blades is positioned away from the nozzle. As the motor burns, the combustion gases ablate or erode a thin member at the center or open a small hole 505 at the center of disk 500, allowing radial thrusting after producing a torque in the axial direction.

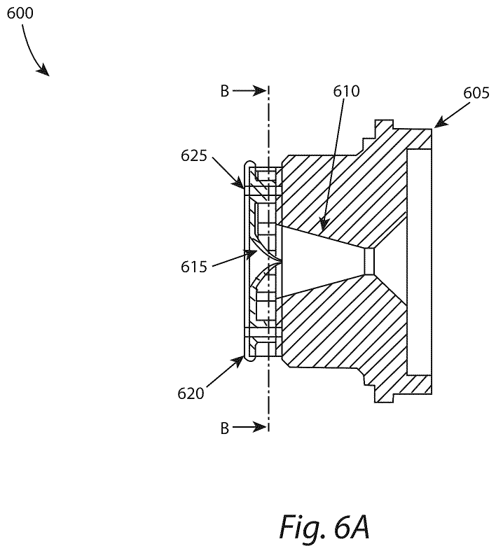

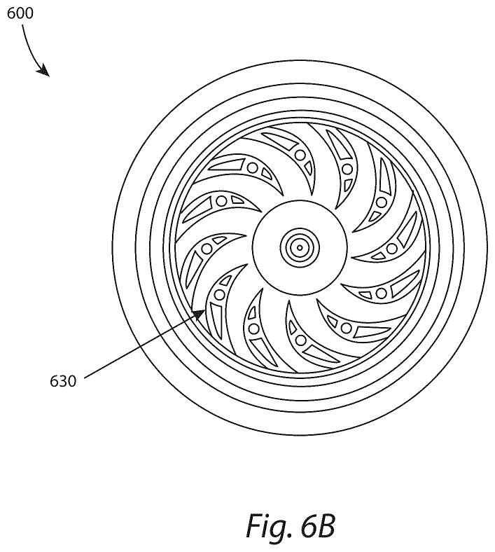

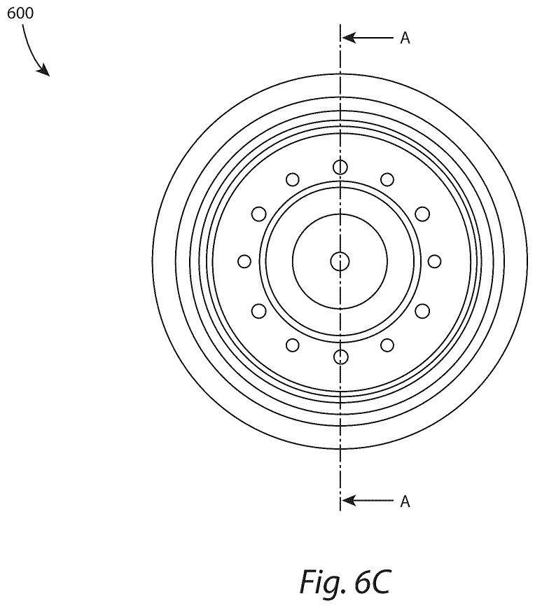

FIGS. 6A-C are diagrams illustrating a one-piece design where the fugacious element and the torque vanes are monolithic, according to an embodiment of the present invention. In FIG. 6A, cross-section of thrust deflector 600 shows a nozzle 605 with a nozzle diverging section 610. Adjacent to, or on the outside side of, thrust deflector 600 is an ablative cone 615 with a retaining ring 620 and through-hole fasteners 625. In FIG. 6B, torque vanes 630 are shown.

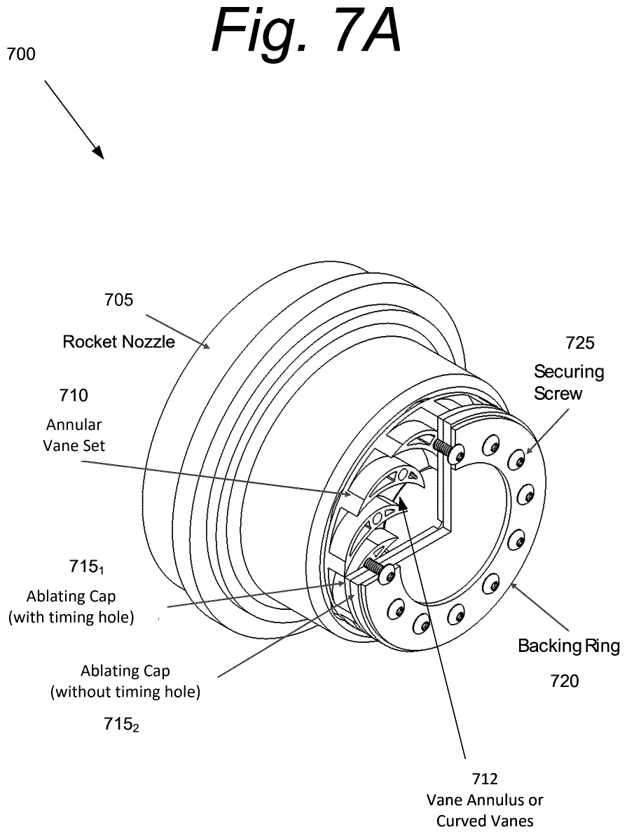

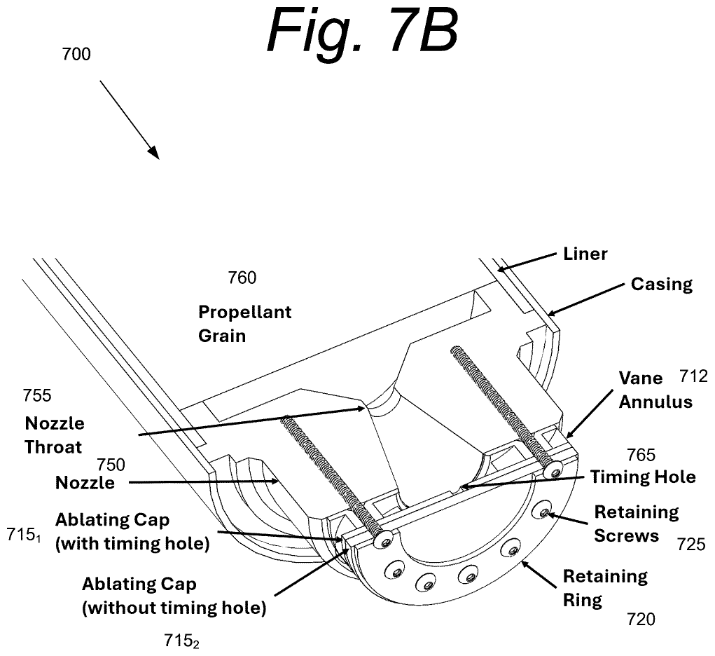

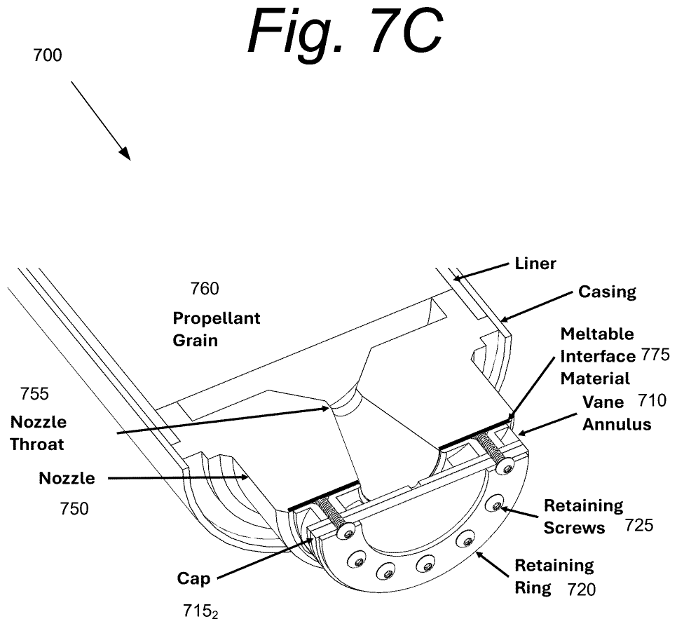

FIG. 7A is a diagram illustrating a motor 700, according to an embodiment of the present invention. In some embodiments, motor 700 includes a rocket nozzle 705, an annular vane set 710, ablating cap 715₁, ablating cap 715₂, backing ring 720, and a plurality of securing screws 725.

Plurality of securing screws 725 are configured to secure ablating cap 715₁ and ablating cap 715₂ between annular vane set 710 and backing ring 720. To summarize, backing ring 720 is similar to a washer under each screw. Imagine that backing ring 720 has a plurality of holes, with the entire backing ring 720 acting a washer for all of screws 725. As shown in FIG. 7B, screws 725 may bring drilled into nozzle securing ablating cap(s) 715₁, 715₂ to motor 700. In some embodiments, securing screws 725 may be meltable screws securing back ring 720 and ablative caps 715₁, 715₂ to nozzle 750.

In these embodiments, ablating cap 715₁ comprises a timing hole 765 or a partial timing hole and ablating cap 715₂ is without a timing hole. In some embodiments, the timing hole 765, a number and thickness of the ablative cap, and composition of the ablative cap controls time and rate of transition from torque to thrust production. In an alternative embodiment, and although not shown, ablative cap 715₁ and/or 715₂ may include a plurality of timing holes in various arrangement (e.g., circular, horizontal, vertical, etc.). Timing hole 765, for purposes of explanation, is a blind or through hole, through one or more plates that allows thrust to be completely, or mostly deflected (greater than 50 percent), usually to produce torque, before burning open to allow the production of thrust. For example, a capping (or ablative) disk 715₁ with a blind (timing) hole 765, blind hole 765 disposed away from the nozzle, initially forces all combustion gases through the annular vanes so that only torque is produced. If a blind hole 765 is used, only after the surface of the plate has been sufficiently ablated, blind hole 765 may communicate combustion gases for thrust production. With the plate already thinned by ablation, blind hole 765 quickly widens, allowing a rapid transition from torque production to thrust production. Centered within the capping disk 715₁, a blind hole 765 or depression would allow a specific point from which ablation advances, allowing a more precise transition from torque to thrust, while reducing the chance or severity of adverse thrust from a less precise, or off-axis burn-through. Likewise, a circular array of small timing or blind holes, centered within the capping disk could achieve a similar result.

Annular vane set 710 includes a set of curved vanes (or vane annulus) 712 that surround the nozzle. See nozzle 750 of FIG. 7B, which is a diagram illustrating a cross section of motor 700, according to an embodiment of the present invention. In certain embodiments, the set of curved vanes 712 surround the nozzle exit.

Although multiple ablating caps (or layers) 715₁, 715₂ are shown in this embodiments, other embodiments may include one or more ablating caps. This is dependent on the design and use of the motor. In these embodiments, ablating cap 715₁ includes a timing hole while ablating cap 715₂ is without a timing hole. In short, depending on the embodiment, there may be one or more ablating caps with a single timing hole or a partial timing hole in the center of the ablating caps.

In certain embodiments, a meltable interface material 775 may be positioned between nozzle 750 and vane annulus 712. For example, FIG. 7C is a diagram illustrating a meltable interface material 775 composed of a glue, wax, or plastic, according to an embodiment of the present invention. In these embodiments, meltable interface material 775 is configured to melt or degrade during thrust, causing vane annulus 712 and the ablative caps 715₁, 715₂ to become unsecured from nozzle 750. For purposes of explanation, propellant grain 760 may be ignited, such that the ignition may flow through nozzle throat 755 and out through vane annulus 712 until meltable interface material 775 degrades or weakens. At such point, the deflecting material, i.e., vane annulus 712, the ablative caps 715₁, 715₂ and any other element that is downstream from nozzle 750 may no longer be secured to the motor.

The benefit one ablating caps is that the materials is easily mixed in matched to achieve an ideal timing. Ideal timing may depend on the needs of the spacecraft. In one example, a 3-U CubeSat might have a deorbit motor installed, with its centerline coincident with the satellite's long axis. The deorbit motor may be furnished with a vane annulus 712 positioned at the exit of the motor nozzle and with that vane annulus 712 capped with one or more ablative disks. Prior to deorbiting, the CubeSat is aligned with its long axis in the ram direction and spun up around the long axis using the satellite's reaction wheel(s). An ignition pulse from the satellite's electronics may ignite the motor so that the motor produces torque in the same direction as the pre-burn spin-up. The intended duration of rocket motor torque production would depend on several design variables, like the mass and mass distribution of the satellite, and whether the satellite has deployable structures like solar arrays, as well s the available motor propellant. Typically, a deorbit burn would be designed to reduce a satellite's perigee to something well under 600 km so that atmospheric drag can quickly complete the deorbiting task. The application of rocket motor torque may be completed in only a second or a small number of seconds for a CubeSat example.

In some embodiments, there is generally a target revolution per minute (RPM) that should be achieved without wasting propellant when the motor is spinning. The quicker the target RPM is reached, the transition from applying torque through annular vane set 710 to applying thrust through timing hole 765 is achieved.

In these embodiments, torque is caused by the configuration of annular vane set 710. The annular vane set 710 generates thrust coming out tangentially from curved vanes of motor 700. Because the thrust comes out of motor 700 tangentially, torque is produced. This may happen on the order of a second or two before ablating caps 715₁ and/or 715₂ are completely ablated (or melt) away. When ablating caps 715₁ and/or 715₂ ablate away, the transition from torque to thrust occurs.

In certain embodiments, the thickness of ablating cap(s) may depend on when the transition between torque and thrust needs to be performed or the target RPM. However, this depends on design choice. Timing hole 765 in some embodiments may be a partial hole or a complete hole. Timing hole 765 gives control of the nature of the burn through. Rocket motors are chaotic in general. This configuration allows the thrust to be produced from motor 700 in an axial direction, while later transitioning to being produced in the radial direction.

It should be appreciated that there may be a stagnation point in the center, where the gas does not have much speed. What happens is that the area around the stagnation point is eroded. This, however, is not preferred, because debris can be produced. By using timing hole 765, the ablating cap(s) ablate (or melt) away without creating space debris.

It should be appreciated that the embodiments use an end burner type of motor 700. When motor 700 is ignited, the burning surface is the face of the propellant grain 760 that is facing nozzle 750. This just burns towards the upper left during operations. It should be noted that composite rockets generally have more complex shapes. Because motor 700 is low thrust, the surface area for burning is limited. To get more thrust, unlike other motors or configurations where the surface area of the burning surface is increased, some embodiments may use a longer motor. For purposes of these embodiments, to determine the length of the motor is thrust×time. Concurrently, the ablating caps are changed to produce the amount of torque that is needed, but quickly transition to producing thrust.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A motor, comprising:
an annular vane set configured to produce torque in a tangential direction when propellant combustion products flow through a nozzle; and
an ablative cap configured to redirect thrust in a radial direction or along a longitudinal, transitioning the motor from producing the torque to generating thrust.

2. The motor of claim 1, wherein the ablative cap comprises a timing hole configured to redirect thrust in the radial direction, transitioning the motor from producing the torque to generating the thrust, wherein
the timing hole, a number and thickness of the ablative cap, and composition of the ablative cap controls time and rate of transition from torque to thrust production.

3. The motor of claim 1, wherein the annular vane set comprises a plurality of annular vanes surrounding the nozzle, and configured to produce the torque along a longitudinal axis.

4. The motor of claim 3, wherein the plurality of annular vanes are configured to generate thrust in a tangential direction.

5. The motor of claim 1, wherein the ablative cap comprises an ablative material configured to ablate or melt away when the motor is generating the thrust.

6. The motor of claim 1, wherein the ablative cap comprises a timing hole in the center and positioned in an axially to a direction of the nozzle
7. The motor of claim 6, wherein the ablative cap together with the timing hole are configured to act as a timing feature, increasing a flow of the thrust from the hole as the hole ablates away.

8. The motor of claim 1, further comprising:
a second ablative cap comprising a circular array of holes near or around a center of the second ablative cap configured to secure the ablative cap to the nozzle.

9. The motor of claim 8, further comprising:
a plurality of meltable securing screws securing a back ring, the second ablative cap, and the ablative cap to the nozzle.

10. The motor of claim 1, further comprising:
a meltable interface material between the nozzle and vane annulus, wherein the meltable interface material is composed of a adhesive, wax, or plastic, and is configured to melt or degrade during thrust, causing the vane annulus, the ablative cap and a second ablative to become unsecured from the nozzle.

11. A motor, comprising:
an annular vane set configured to produce torque in an tangential direction when propellant combustion products flow through a nozzle; and
an ablative cap configured to redirect thrust in a radial direction or along a longitudinal, transitioning the motor from producing the torque to generating thrust, wherein
the ablative cap comprises a timing hole configured to generate thrust in the radial direction, transitioning the motor from producing the torque to generating the thrust.

12. The motor of claim 11, wherein the annular vane set comprises a plurality of annular vanes surrounding the nozzle, and configured to produce the torque along a longitudinal axis.

13. The motor of claim 12, wherein the plurality of annular vanes are configured to generate thrust in a tangential direction.

14. The motor of claim 11, wherein the ablative cap comprises an ablative material configured to ablate or melt away when the motor is generating the thrust.

15. The motor of claim 11, wherein the ablative cap comprises a timing hole in the center and positioned in an axially to a direction of the nozzle

16. The motor of claim 15, wherein the ablative cap together with the timing hole are configured to act as a timing feature, increasing a flow of the thrust from the hole as the hole ablates away.

17. The motor of claim 11, further comprising:
a second ablative cap comprising a circular array of holes near or around a center of the second ablative cap configured to secure the ablative cap to the nozzle.

18. The motor of claim 17, further comprising:
a plurality of meltable securing screws securing a back ring, the second ablative cap, and the ablative cap to the nozzle.

19. The motor of claim 11, further comprising:
a meltable interface material between the nozzle and vane annulus, wherein the meltable interface material is composed of an adhesive, wax, or plastic, and is configured to melt or degrade during thrust, causing the vane annulus, the ablative cap and a second ablative to become unsecured from the nozzle.

20. A motor, comprising:
an annular vane set configured to produce torque in a tangential direction when propellant combustion products flow through a nozzle; and
a first ablative cap and a second ablative cap configured to redirect thrust in a radial direction or along a longitudinal, transitioning the motor from producing the torque to generating thrust when the annular vane set ablates or melts away.
